(19) United States
(12) Patent Application Publication
(10) Pub. No.: US 2020/0229998 A1
(43) Pub. Date: Jul. 23, 2020

(54) SMART TILTING/LIFTING CHAIR WITH THE ABILITY TO TILT USER TO VERTICAL POSITION

(71) Applicant: Ohad PAZ, Plantation, FL (US)

(72) Inventor: Ohad PAZ, Plantation, FL (US)

(21) Appl. No.: 16/683,299

(22) Filed: Nov. 14, 2019

Related U.S. Application Data
(60) Provisional application No. 62/766,970, filed on Nov. 14, 2018.

(51) Int. Cl. A61G 5/10; A61G 5/14; A61G 5/12; A47C 7/72

(52) U.S. Cl. CPC A61G 5/1067; A61G 5/14; A61G 2203/18; A47C 7/72; A61G 2203/34; A61G 5/128

(57) ABSTRACT

A Chair having at least two axis (pivots) which connects three parts—Back-rest, Seat and Leg-rest having a footboard connected to it at the feet side in which the Axle/Pivot of the tilting, when the chair is in seating position, is higher than the Seating support surface.

### RELATED APPLICATION(S)

This application claims the benefit of priority under 35 USC § 119(e) of U.S. Provisional Patent Application No. 62/766,970 filed on Nov. 14, 2018, the contents of which are incorporated by reference as if fully set forth herein in their entirety.

### FIELD, BACKGROUND & SUMMARY OF THE INVENTION

This disclosure describes a New Lifting/Tilting Chair which can Tilt people to a fully standing position. The Chair is a “smart” chair having special technical innovative movements and/or has special IT features.

The present disclosure relates to a chair, Arm-chair, Recliner, with the ability to Tilt the user from a seating or lying position into a standing position and optionally all in between positions, having special innovative abilities.

The Smart Lift/Tilt Chair may also include a Tablet to control the Chair position and to allow connectivity of to, for example, a smart Home, phone, Emergency remote connection, Hospitals, Doctors, operating Television and any using any other Application from and by connected Tablet to the chair.

### Today's Chairs in the Market—

The lift chairs of today in the market are chairs which lifts the user to, with no foot support, without a good grip on the arm-rests/handles. The existing chair lifts the user up to about 45 degrees to a dangerous position, in which he can slide, fall, lose his balance and get injured.

The Smart Tilt Chair concept (STC)—

An object of some embodiments of this invention is providing a chair which will allow the user to lift himself from seating, lying or any position, to a full standing position, allowing him to walk from the chair. The chair is able to keep the user in flat position over the support surface of the chair, and optionally in any angle between around minus fifteen (−15) to ninety (90) degrees, which potentially gives many medical advantages.

The chair will optionally have a motorized movable footboard, which can move in and out of its central position, to extend leg space and to move towards the head in order to touch the feet before tilting so the user will not slide while tilted.

During the Tilt movement the Footboard will optionally change its position so at the end of the tilting function the footboard will touch the floor, potentially allowing the user to safely step out of the chair.

The chair may be designed in a way that the Tilt Pivot is higher than the seating support surface, so when the chair is tilting the seat support tilts and also raised, which allows enough space for the full tilt and still keeping the seat surface low enough, in a height suitable for armchairs.

The chair will also optionally have special arm rests which will change its position according to the angle of the chair, to allow comfortable and safe use of the user.

The Smart Lift Chair may include one or more or even all of the following features—

1. Has a foot board which is movable by an actuator, towards the head of the chair and out of the leg-rest.

2. The footboard will allow the user to move it towards his feet until touches, so the footboard supports the user while he moves to a standing position preventing the user from sliding.

3. The footboard may move by user command and by predefined program commands according to the chair position.

4. Such footboard may extend out of the chair center position, in order to give more space when leg-rest is raised, in order to prevent pressure on the user feet.

5. Such footboard may move in and out for physical therapy of the user.

6. Such footboard may have a sensor which will send a signal when the footboard is pressed by the user.

7. Such footboard may have a scale integrated.

8. Such footboard may have a sensor on its outer side for preventing the footboard from pressing on an object or someone, during the end of the tilting.

9. The Chair has armrests, one or two special handles to operate some functions of the chair by the user while having a safe grip. In this disclosure we will call it Vertical Argo Stick—“VAS”.

THE VAS may have a control button to electrically operate the chair to move it at least to standing and lying position, but can also optionally move the user to lying and seating position,

10. On the arm rest there can be an additional operating button in a location, which will allow the user to reach it, while in lying position or any other position in the chair. So He will always be able to reach an operating button.

11. The arm rests will change their position according to the angle of the backrest of the chair, or the full chair angle, for example as predefined and can be changed, for the comfort of the user. As the angle of the relevant support surface changes the arm rest angle will change. Such angle position can be changed using an actuator connected to a program or a mechanical structure causing the change of the armrest angle in respect to one of the support surface angles.

12. The Chair movement can be controlled by a controller having a program which be changed remotely with the special connectivity of such controller.

13. For supporting the user when moving to tilting position there will be air sleeves from the side of the upper part of the chair, which can be inflated and deflated, for supporting the user not to fall when tilted.

14. Such sleeves can also be on the lower extremities' areas.

15. The above sleeves may have sensors to control the pressure on the user body.

16. A sensor may be placed in any area of the chair for detecting use of the chair.

17. The chair may be upholstered (e.g., in contact with the body and/or on the outside of the chair) and/or appear and function as an arm chair, optionally as a recliner, for example, in a living room or a bedroom setting.

18. When in a seated state, the recliner optionally is smaller than 1.2 meter by 1.2 meter footprint. For example, the recliner width may be 40 cm, 60 cm, 80 cm, 100 cm or smaller or intermediate or greater sizes. For example, the recliner depth may be 40 cm, 60 cm, 80 cm, 100 cm or smaller or intermediate or greater sizes.

19. The chair may have a Tablet which will be connected to the operating system of the chair through one or more of—
Wi-Fi
Infra-Red
Wired
Bluetooth
Any other commercial connectivity possibility

### Possible Compatibility of Technology for the Tablet.

IOS operating systems for apple and Mac systems
Android operating system.
Windows operating systems
Any other operating systems.

### Tablet Capabilities and Functionality—

The Tablet can be a part of the Smart Chair and is able to operate the chair, but can optionally also be used for one or more of the following operations—
Use any operating system, as Android, IOS, windows or any other system, for operating Applications.
Operate as phone.
Can control the electronics at home (Smart Home).
Any application, as emergency call, Medicine reminder and control, any communication App etc.
Any recording Application.
Wi-Fi/Bluetooth/EF or any other connectivity.
The Tablet may have a camera.
Such camera can send pictures of the user in case the user is in a certain position.
Can identify if the user is seating in the chair. If not in a defined time, can send a signal or call a pre-defined third party or system, giving an alert.
Can identify bad position of the user (as head fall to side or front).
Can see other important pre-defined characters of the user and in case the user current condition does not meet such pre-defined characteristics, it will notify a pre-defined third party/system, of such incident.
The Tablet can remind the user to take medication.
Can remind the user to do exercise.

20. The chair may be operated by voice recognition.

21. The Tablet integrated in the chair can be connected to Vital Signs diagnostic and collect such vital signs of the user.

a. Can send information to predefined contact in case does not meet a predefined character.

22. The Tablet can collect (and optionally log in a memory) all the chair positions, which may be used in order to give the history of the chair use.

23. The chair can come in various sizes to allow smaller and bigger people.

24. The Chair can have a power drive (e.g., with ground contacting wheels) for moving the chair with the user.

25. The chair may have armrests/handle connected to the side of the backrest or the seat. In some designs the handles are not fixed and will have an independent mechanism which will change the angle of the armrest in respect to the backrest, according to the angle between the backrest and the seat support or the angle of the seat support in respect to the floor, or a combination of the two. This is potentially important as it is good to have different angles of the handles/armrest support, in different angles of the chair parts, in respect to each other and in respect to the floor.

26. The Chair can have a special pressure sleeves for preventing user to fall out of the chair and to support the user in standing position.

The sleeves are connected to an air compressor and will be controlled in a way that the user will be able to activate and deactivate and also have a controlled auto function to inflate and deflate as predefined.

The location of such inflatable sleeves can be anywhere along the chair, from chest area to feet.

27. The chair will have the ability of having a massage function.

28. The chair, having a massage function may have an inflatable part on the back side of user, to prevent the user from feeling the massage parts when not in use. It can be inflated when massage function is not in use and deflated when massage action is in use.

### BRIEF DESCRIPTION OF THE SEVERAL VIEWS OF THE DRAWING(S)

The invention is herein described, by way of example only, with reference to the accompanying drawings, wherein:

FIG. 1 illustrates one form of the Chair, in its seating position, with seat support being reclined to about (−7) degrees, in accordance with some embodiments of the invention;

FIG. 2 illustrates the Chair of FIG. 1 of the invention of the present application having the Chair in its Fully Tilted position, being close to 90 degrees and having the Footboard almost touching the floor, or touching the floor, in accordance with some embodiments of the invention;

FIG. 3 illustrates the Chair of FIG. 1 in a horizontal position, having the leg-rest support raised to about the level of the seating support, being almost parallel to the headboard support and having the handles changing its position respectively, in accordance with some embodiments of the invention;

FIG. 4 illustrates the Chair of FIG. 1 and FIG. 2, in an almost vertical position, having the handles changing its angle in respect to the floor respectively, in accordance with some embodiments of the invention;

FIG. 5 illustrates a sample of a handle of the Chair in FIG. 3, showing another control button on the armrest handle and a control button on top of the vertical handle coming out of the armrest handle, and both control buttons are part of the Chair operation, in accordance with some embodiments of the invention;

FIG. 6 illustrates a possible connection of a Tablet to the Chair of FIG. 1, in accordance with some embodiments of the invention;

FIG. 7 illustrates the Chair in this invention being in a recline position, with the ability of adjusting the height of the footboard, in accordance with some embodiments of the invention;

FIG. 8 illustrates the Chair of this invention, being in almost horizontal position and having the handles in an angle respectively to the floor, which helps the user reaching them, in accordance with some embodiments of the invention;

FIG. 9 illustrates the Chair as in FIG. 2, showing how a person can step out of the Chair while the Chair is in Vertical or almost Vertical position, in accordance with some embodiments of the invention; and

FIG. 10 illustrates the Chair of this invention being in around 40 degrees angle respectively to the floor, showing the axle where the Tilt pivot is connected, in accordance with some embodiments of the invention.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF SPECIFIC EMBODIMENTS OF THE INVENTION

The features below to be considered optional as not all features listed below need be provided in an exemplary chair.

1. A Chair having at least two axis (pivots) (REFERENCE 1.5 & 1.7) which connects to three parts—Backrest (REFERENCE 1.1), Seat (REFERENCE 1.2) and Leg-rest (REFERENCE 1.3). Such leg-rest has a footboard connected to it at the feet side (REFERENCE 1.4). Such foot board is connected to an electric actuator allowing it to move in a linear movement toward the feet (head side) of the patient and to the opposite direction (REFERENCE 3.8).

The Axle/Pivot of the tilting (REFERENCE 1.5, 3.3, 4.4) is, when in seating position, higher than the Seating support surface (REFERENCE 1.2, 3.7). Which allows the chair to be low enough as a regular armchair. This structure allows the seating support surface, which is connected to the leg-rest and footboard, to raise while tilting, so there is enough height from the floor to achieve full tilt as in FIGS. 2 and 4.

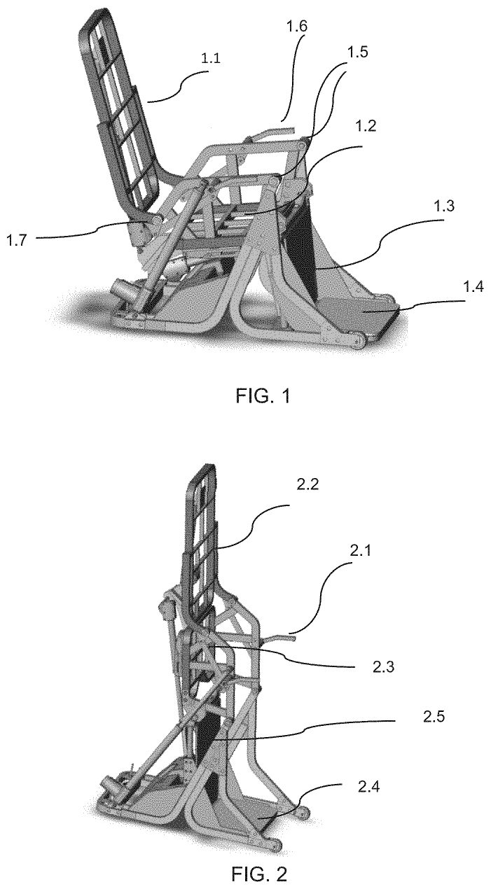

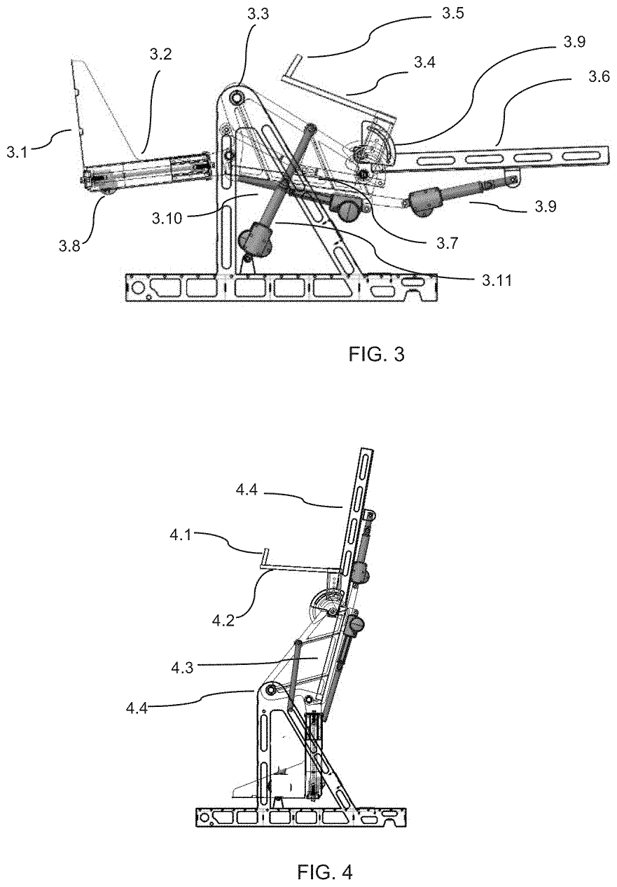

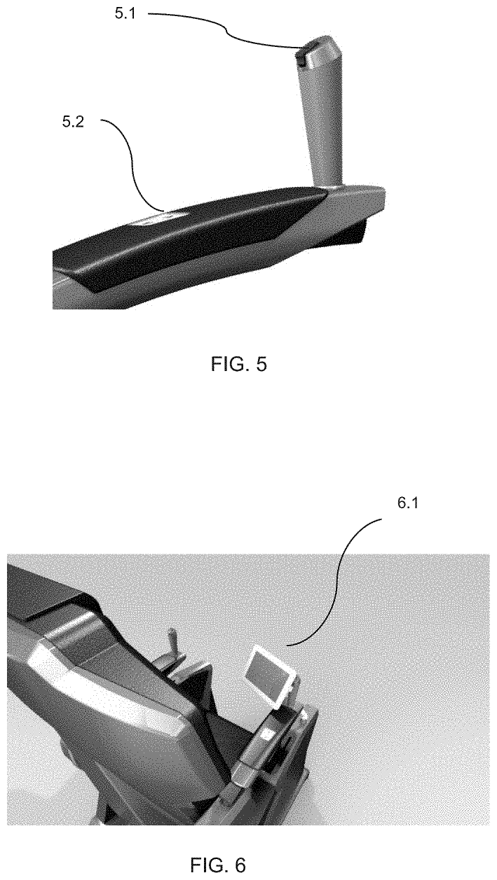

2. The chair has at least two electric actuators for moving the Chair (apparatus) to various positions, including Seating/Reclining position (FIG. 1), Lying position (FIG. 3) and Standing position (FIG. 2).

3. The Actuators can be connected to a controller which can be pre-programmed to define the movement of the different parts of the chair.

4. Examples for possible operation of the chair—

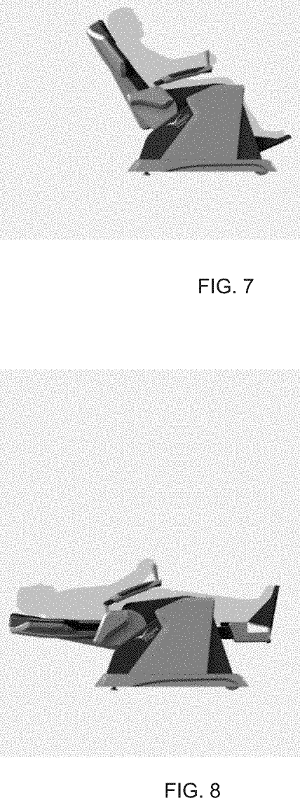

a. From seating position to standing position (FIG. 7 to FIG. 8 and FIG. 9)—By pressing a button on handset or the button on the vertical handle (REFERENCE 5.1), the controller gets the command to do the following processes—Moves backrest Down by closing backrest actuator (REFERENCE 3.9), Move leg-rest up and footboard out, by opening leg-rest (REFERENCE 3.10) and footboard actuators (REFERENCE 3.8), move footboard in until touches the feet by closing footboard actuator (REFERENCE 3.8), and tilt by opening the tilt actuator (REFERENCE 3.10). While user is tilted the footboard carrying the user feet will move down, so when fully tilted the footboard is touching the floor or in close position (REFERENCE 2.4).

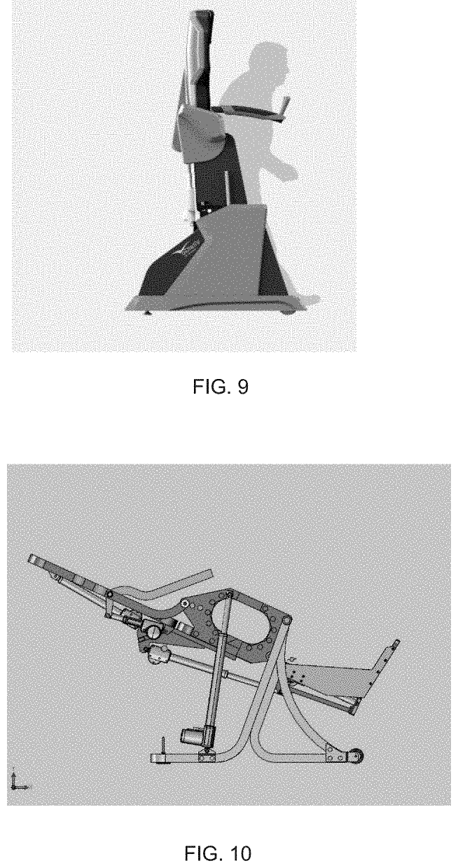

b. From Fully tilted to seating position (FIG. 9 to FIG. 10 and to FIG. 7)—By pressing a button on the handset the footboard will be raised by moving footboard actuator, The chair will tilt down by closing tilt actuator. Backrest will be raised by opening backrest actuator and leg-rest will move down by closing leg-rest actuator.

All movements of any part of the chair, i.e. Backrest, Leg-rest, footboard, seat can be moved independently by moving actuator which is connected to the relevant part.

5. The chair may have on its armrest/Handles (REFERENCE 1.6, 2.1, 3.4), vertical stick (REFERENCE 3.5) connected to at least one of the arm-rests.

6. The chair may have handles which can be connected to the side of the backrest (REFERENCE 3.4) or the armrest (REFERENCE 1.6, 2.1). Such handles have a mechanism (REFERENCE 3.9) which is changing the angle in respect to the angle between the seat support and the backrest or the angle of the seat support in respect to the floor or a combination of the two (REFERENCE 1.6, 2.1, 3.4).

7. Such angle change of the armrests may be done with a mechanical structure (REFERENCE 3.8) or by an electric actuator connected to the armrest and controlled by the chair main controller, having a program which define its position in respect to the other actuators position.

The angle between the handle and the backrest and seat support will change as seen in (FIGS. 1 to 4).

8. The chair will allow the user moving to any seating position, with legs down, up, backrest up, down, to a tilting position and Trendelenburg position (FIGS. 1, 2 and 3).

9. Such chair (apparatus) can be in a size of a chair/Arm-chair. The chair can come in different dimensions to allow smaller and bigger people.

10. The footboard connected to the Leg-rest may move in and out for physical therapy of the user.

11. Such footboard may have a sensor which will send a signal when the footboard is pressed by the user.

12. Such footboard may have a scale integrated.

13. Such footboard may have a sensor on its outer side for preventing the footboard from pressing on an object or someone, during the end of the tilting.

14. The Chair has armrests, on which it has one or two special vertical handles (REFERENCE 2.1 & 3.5) to operate some functions of the chair by the user while having a safe grip.

The vertical handle (REFERENCE 1.6, 2.1, 3.5, 4.1) may have a control button (REFERENCE 5.1) to electrically operate the chair to move it at least to standing and lying position, but can also move the user to any seating angle position.

15. On the arm rest there can be an additional operating button in a location (REFERENCE 5.2), which will allow the user to reach it, while in lying position or any other position in the chair, so He will always be able to reach an operating button.

16. The chair may have a Tablet (REFERENCE 6.1) which will be connected to the operating system of the chair through—
Wi-Fi
Infra-Red
Wired
Bluetooth
Any other commercial connectivity possibility

### Optional Compatibility of Technology for the Tablet.

IOS operating systems for apple and Mac systems
Android operating system.
Windows operating systems
Any other operating systems.

### Tablet Capabilities and Functionality—

The Tablet can be a part of the Smart Chair and is able to operate the chair, but may also be used for one or more of the following operations—
Use any operating system, as Android, IOS, windows or any other system, for operating Applications.
Operate as phone.
Can control the electronics at home (Smart Home).
Any application, as emergency call, Medicine reminder and control, any communication App etc.
Any recording Application.
Wi-Fi/Bluetooth/EF or any other connectivity.
The Tablet may have a camera.
Such camera can send pictures of the user in case the user is in a certain position.
Can identify if the user is seating in the chair. If not in a defined time, can send a signal or call a pre-defined third party or system, giving an alert.
Can identify bad position of the user (as head fall to side or front).
Can see other important pre-defined characters of the user and in case the user current condition does not meet such pre-defined characteristics, it will notify a pre-defined third party/system, of such incident.
The Tablet can remind the user to take medication.
Can remind the user to do exercise.

17. The chair may be operated by voice recognition.

18. The Tablet integrated in the chair can be connected to Vital Signs diagnostic and collect such vital signs of the user.

a. Can send information to predefined contact in case does not meet a predefined character.

b. The Vital Sign connectivity may send information to the “Cloud” and to a predefined algorithm for determining the medical condition of the user and to signal in case of a health problem of same user.

19. The Tablet can collect all the chair positions, in order to give the history of the chair use.

20. The Chair can have a power drive for moving it with the user.

21. The Chair may have pressure inflatable sleeves for preventing user to fall out of the chair and to support the user in standing position. The inflatable sleeves may come from one or two sides of the chair, supporting different areas of the body, as chest, knees, feet waist etc.

The sleeves can be connected to an air compressor and can be controlled in a way that the user will be able to activate and deactivate and/or having a controlled auto function to inflate and deflate as predefined.

Such Inflatable sleeves may have a pressure sensor for adjusting the amount or pressure on the body.

22. The chair may have the ability of having a massage function.

23. The chair, having a massage function may have an inflatable part on the back side of user, to prevent the user from feeling the massage parts when not in use. It can be inflated when massage function is not in use and deflated when massage action is in use.

What is claimed is:

1. A Chair having at least two axis (pivots) (REFERENCE 1.5 & 1.7) which connects three parts—Back-rest (REFERENCE 1.1), Seat (REFERENCE 1.2) and Leg-rest (REFERENCE 1.3) having a footboard connected to it at the feet side (REFERENCE 1.4) in which the Axle/Pivot of the tilting (REFERENCE 1.5), when the chair is in seating position, is higher than the Seating support surface (REFERENCE 1.2).

2. The footboard in claim 1 is connected to an electric actuator allowing it to move in a linear movement toward the feet (head side) of the patient and to the opposite direction (REFERENCE 3.1 and 3.2).

3. The Chair in claim 1 can have a controller with ability to program the chair movement.

4. The chair in claim 1 can have electric actuators.

5. The chair in claim 1 can have armchairs and hand support which can change its angle according to the angle of the seat support surface and the backrest support.

6. The Chair in claim 1, can have inflatable sleeves for supporting the patient which the chair is tilted, in a way it supports the patient from falling.

7. Such sleeves in claim 6 can have a pressure sensor.

8. The chair in claim 1 can have a sensor on the footboard.

9. Chair in claim 1 can have a tablet connected to it with ability to control the chair movement in different means, as pressing, as voice recognition and eye movement.

10. Such tablet in claim 9 can have a camera connected or integrated for taking images and videos of the user, for detection of patient position and look.

11. The chair in claim 1 can have a massage function.
